(19) United States
(12) Patent Application Publication
(10) Pub. No.: US 2005/0238067 A1
(43) Pub. Date: Oct. 27, 2005

(54) Simple fiber optic cavity

(76) Inventor: Youngmin A. Choi, Agoura Hills, CA (US)

Correspondence Address: Youngmin A. Choi, 5410 Isabella Ct., Agoura Hills, CA, 91301, US

(21) Appl. No.: 10/831,752

(22) Filed: Apr. 26, 2004

(51) Int. Cl. H01S 3/10

(52) U.S. Cl. 372/20; 372/6; 372/99

(57) ABSTRACT

A novel Fabry-Perot resonance cavity has been recognized. This cavity is formed by simple planar and concave (or two concave) mirrors—attached at the fiber ends. The concave mirror is precisely aligned to the core of the fiber. The concave lens is fabricated on the end of the fiber by making an indentation of correct geometry and smoothness. The concave mirror has multiple dielectric layers applied on the concave lens to achieve the final, desired optical characteristics.

### FIELD OF THE INVENTION

The present invention relates generally to a simple symmetric or asymmetric resonance cavity. The cavity is formed by either a simple planar and concave mirror (FIG. 3) or two concave mirrors (FIG. 4) which are attached at the end of the each of the fibers. Furthermore, FIG. 3 can be modified as shown in FIG. 5 by replacing the fiber with a detector. The concave lens is fabricated on the end of the fiber by making an indentation of correct geometry and smoothness. The concave lens is precisely and easily located to the core of the fiber. The concave mirror has multiple dielectric layers applied on the concave lens such that the final optical characteristics are as desired. This construction is significantly simpler and more reliable than that used in the prior art.

### BACKGROUND OF THE INVENTION

The main problems with conventional optical resonance cavities are their complexity and reliability. These devices are not easily built and much less reliable since they consist of a plethora of devices such as a fiber guide and antireflection coating requiring complex manufacturing steps, and complex alignment fixture. This requires a multitude of manufacturing steps. In addition, properly aligning the mirrors can be difficult and time-consuming, resulting in a complex, less reliable, and expensive resonance cavity. The assembly of such devices is lengthy and problematic requiring complicated alignment and holding fixtures for the mirrors. FIG. 1 is an example of the construction prevalent to date. FIGS. 1 and 2 show the complex structure, precision alignments and alignment tooling needed to achieve a cavity. In these respects, the simple resonance cavity according to the present invention substantially departs from the conventional concepts and designs of the prior art, and in so doing, provide an apparatus primarily developed for providing a cavity which can be tuned.

### SUMMARY OF THE INVENTION

In view of the foregoing disadvantages inherent in the known types of optical cavities now present in the prior art, the present invention provides a simple resonance cavity construction.

The general purpose of the present invention, which will be described subsequently in greater detail, is to provide a novel optical resonance cavity that has many of the advantages of the optical resonance cavity mentioned heretofore and many novel features that result in a novel optical resonance cavity which is not anticipated, rendered obvious, suggested, or even implied by any of the prior art optical resonance cavity either alone or in any combination thereof.

### BRIEF DESCRIPTION OF THE DRAWINGS

Various objects, features, and attendant advantages of the present invention can be fully appreciated as the same becomes better understood when considered in conjunction with the accompanying drawings, in which like reference characters designate the same or similar parts throughout the several views, and wherein:

FIG. 1 is a view of prior art showing the complexity inherent therein.

FIG. 2 is a view of prior art showing the complexity inherent therein.

FIG. 3 is a schematic view of the asymmetric optical cavity formed between a planar and concave mirror.

FIG. 4 is a schematic view of the asymmetric optical cavity formed between the two concave mirrors which have different curvatures.

FIG. 5 is a schematic view of the asymmetric optical cavity formed between a planar and concave mirror, with a detector replacing one fiber.

FIG. 6 is a schematic view of the asymmetric optical cavity formed between a concave mirror and VECEL with planar mirror, with a VECEL replacing one fiber.

FIG. 7 shows a planar mirror at the end of a fiber.

FIG. 8 shows a concave mirror at the end of a fiber.

FIG. 9 shows another method of providing a concave mirror at the end of a fiber.

FIG. 10 shows a concave lens at the end of a fiber.

FIG. 11 shows another method of providing a concave lens at the end of a fiber

FIG. 12 shows a method of providing a spherical surface at the end of a fiber.

FIG. 13 shows another method of providing a spherical surface at the end of a fiber.

FIG. 14 shows the interference pattern of a concave lens.

FIG. 15 shows the transmission characteristic of a concave and planar cavity.

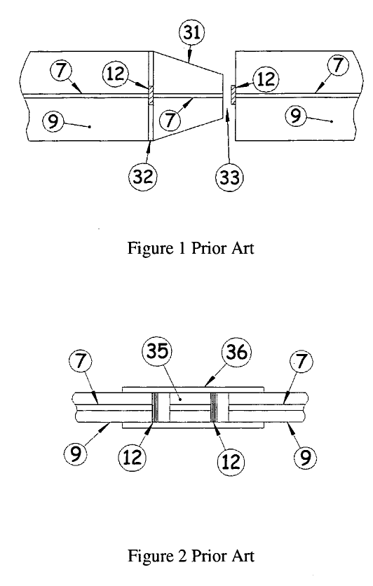

### DESCRIPTION OF THE PREFERRED EMBODIMENT

Turning now descriptively to the drawings, in which similar reference characters denote similar elements throughout the several views, the attached figures illustrate novel cavities with optical fibers and two mirrors.

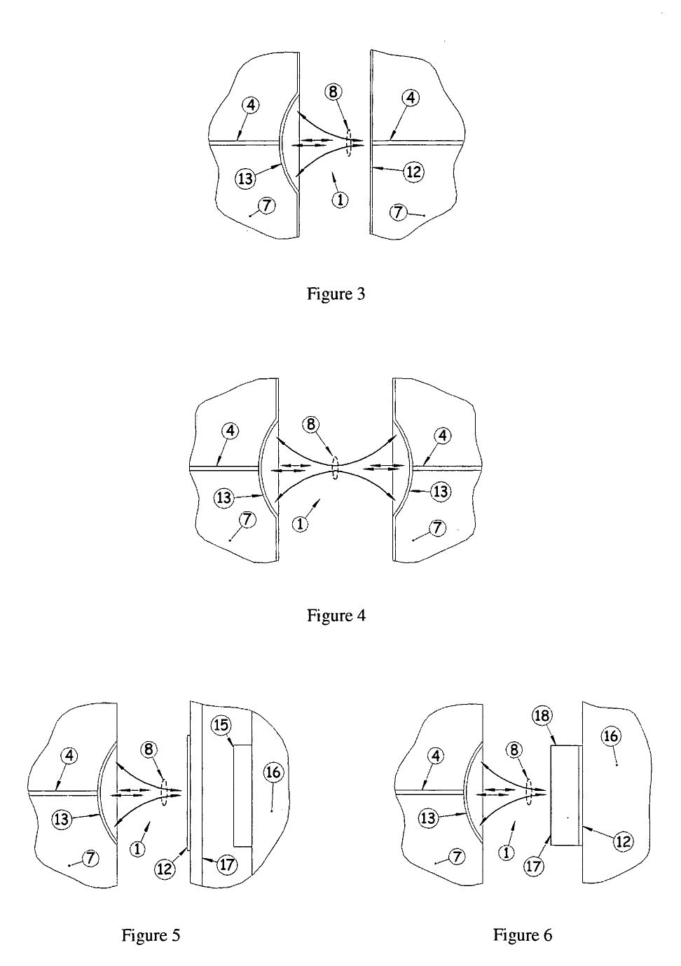

FIGS. 3, 4, 5 & 6 show several embodiments of different cavities that can be formed within the scope of the current invention. While each is different from the other, the same principle regarding simplicity applies to each.

In turn:

FIG. 3 shows a schematic view of the asymmetric optical cavity formed between a planar (12) and concave (13) mirror. In this case, the concave mirror is precisely aligned to the core of the fiber (4). The planer mirror is located perpendicular to the fiber core. When such a construct is aligned and light in the suitable wavelength range passes through the fiber core, a cavity (1) makes the light (8) to bounce back and forth between the concave and planer surfaces as shown. This cavity is the basis of a multitude of variants, some of which are described herein.

FIG. 4 shows a schematic view of an asymmetric optical cavity formed between the two concave mirrors which have different curvatures. This is a special case where the planar mirror on FIG. 3 is replaced by a second concave mirror. In such a case, the concave mirrors are located precisely to the core of the fiber. When such a construct is aligned and light of a suitable wavelength is passed along the fiber core, a cavity (1) makes the light (8) to bounce back and forth between the concave surfaces as shown.

FIG. 5 shows a special case where the fiber with planar mirror on FIG. 3 is replaced with a photodetector (15). However, the mirror is deposited on a substrate (17) and functions as described before for the cavity thus formed. In this case, however, the tolerances for the location and alignment of the photodetector (15) are not critical.

FIG. 6 shows a special case where the fiber with planar mirror on FIG. 3 is replaced with a Vertical Cavity Surface Emitting Laser (VCSEL). However, the mirror is deposited on the surface (16), an antireflection coating can be deposited on the top of the VCSEL, and functions as described before for the cavity thus formed. In this case, however, the tolerances for the location and alignment of the VCSEL (18) are not critical.

The fiber is an amorphous structure used to guide light. The fiber (7) is composed of fused silica glass with a central core (4) of higher refractive index glass. Light is guided and bound in the core by means of the difference in refractive index between the core and the surrounding glass. In order to protect the glass a single coating or multiple coatings of protective polymer are deposited. The input fiber geometry allows only one mode of light to propagate. The output fiber can be single mode or multimode fiber. While the fibers have been identified as input fiber and output fiber, this does not imply that this is mandatory for operation. Indeed, optical loss and performance are independent of the launch direction. In certain embodiments, the fiber with planar mirror (6) could be replaced by a suitable photodetector.

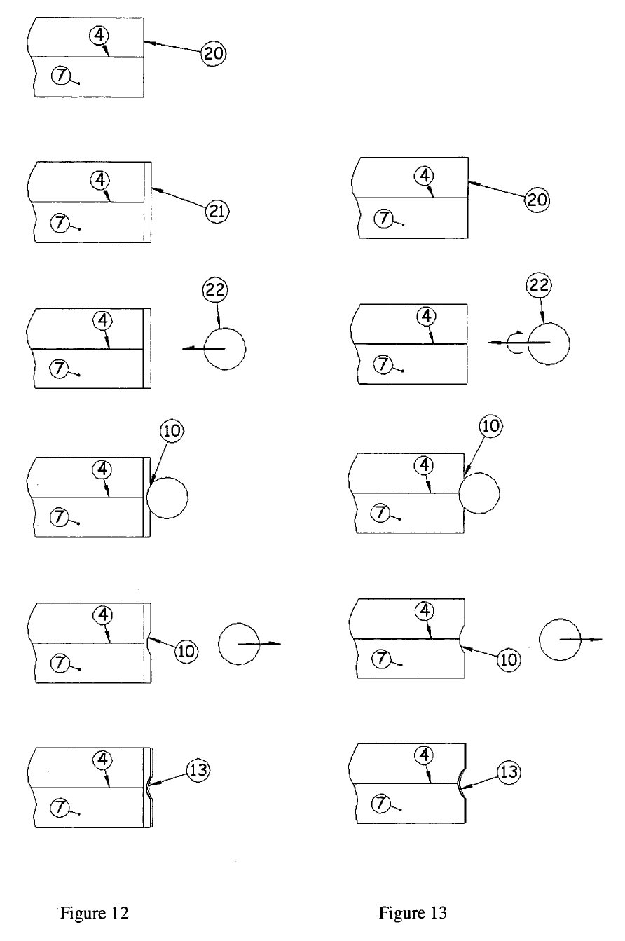

The fiber (7) is used to guide and contain light. In addition, the fiber provides a structure on its end (20) on FIG. 12 to form a suitable surface having the desired surface contour, reflectivity and transmittance. This can be achieved in a number of ways as previously described. The cavities can thus be achieved using the constructs described and are shown in FIGS. 3, 4, 5 and 6. The interrelationship of the optical parameters of the mirror characteristics are important for achieving the performance of the optical cavity.

The light exits the fiber core (4) into the cavity (1) and begins to expand in a well-defined and understood manner (8). On impinging on the surface of the other fiber, the light is reflected back to the other surface of the fiber where again it is reflected back. Thus, a cavity is made which has multiple reflections between the ends of the fiber. The defining characteristic of the cavity is its finesse, with higher being usually desirable. The device thus described in operation can also be configured in a plethora of ways and using the same principles measure physical phenomena by monitoring the wavelength of the transmitted light. Further, as described earlier other embodiments are possible and can be used to monitor optical systems. The said device can also be manufactured using existing technologies to yield a low cost, highly reliable, high performance device with reduced complexity and physical size.

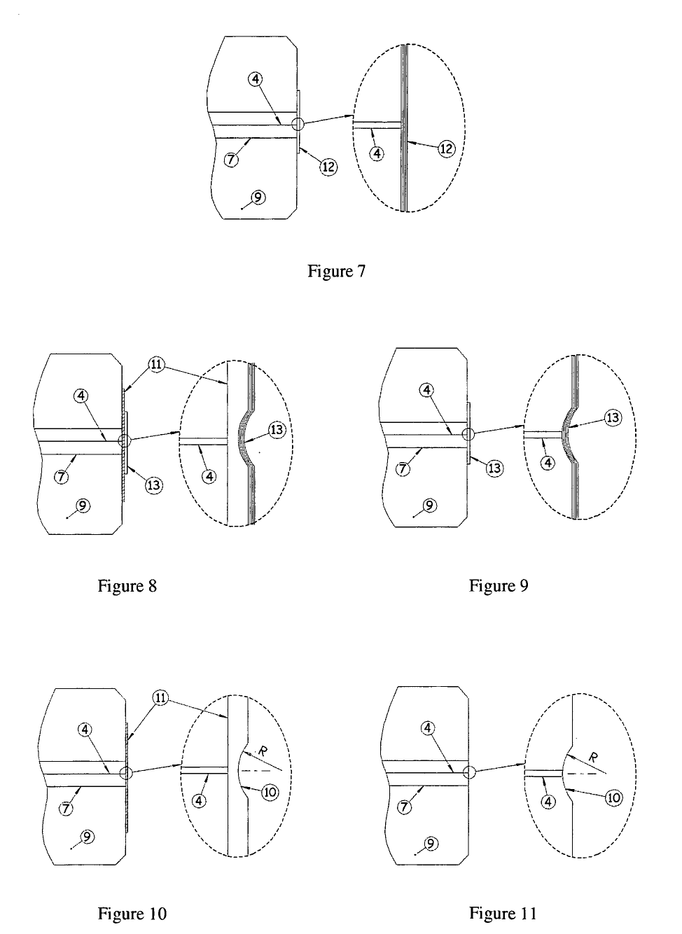

The mirror is a structure comprising of a surface with a desired degree of reflectivity and transmittance. The mirrors (12) & (13), as seen in FIGS. 7, 8, and 9, are composed of a dielectric coating of finite thickness and composed of multiple layers. The mirrors are deposited on the end of the optical fibers (7), which have been suitably prepared to accept such coatings. Typically, the fibers (7) are bonded into ferrules (9) which allow for handling and polishing with no damage to the fiber. While fiber ferrules (9) are used in the current embodiment, this is not essential. Indeed, the ferrule does not provide any necessary function other than ease of handling.

While the mirrors (12) & (13) are discussed as separate entities, this does not mean that a separate material be present to provide such a structure. Anyone skilled in the art would know that a mirror is characterized as having specific surface properties. Depending on the required properties, a plethora of techniques can be used to provide such a desired surface. Some of these techniques may use the addition of different materials to achieve the desired properties. The current embodiment utilizes separate materials to provide a medium for the manufacture of a suitable lens structure.

It is also shown that the mirror (13) does not extend over the entire surface of material (11) and thus comes in contact with a face (20) on FIGS. 12 and 13. Indeed, the mirror (13) need only cover surface (10) as shown by FIG. 8. This prevents undesirable stresses at the boundary of (11) and thus inhibits cracking within the mirror construct (13). This is achieved by installing the ferrule into suitable tooling such that the desired coating area is exposed and the undesirable area is covered. When exposed through the desired aperture in the tooling, the dielectric mirror is then formed as a result of depositing multiple layers of specific properties. Further, the tooling can be designed to accommodate a number of ferrules thus reducing processing cost. The tooling can be of any desirable configuration.

After the formation of the desired mirror, the optical properties can be subsequently measured. This can be achieved by assembling a resonant cavity and measuring its characteristics. This allows the mirror to be measured and all the mirrors deposited at the same time will have similar properties sufficient to adequately characterize the batch.

Depositing the mirrors is done at an elevated temperature. This can result in the change in the shape of the curvature undesirably and thus impairing performance. However, the current process has selected specific materials and thermal deposition profiles which result in minimal distortion of the critical shape of the concave lens. This combination of materials allows for processing at higher temperatures thus resulting in an optimum mirror and lens performance and stability.

FIGS. 10 and 11, shows a possible configuration of a spherical surface (10) of radius R, formed at the end of the optical fiber (7). The preferred embodiment utilizes a spherical concave mirror (13) on FIGS. 8 and 9, the apex of which is centered on the output fiber core (4) as shown in FIG. 11. FIG. 10 shows a similar construct (13) using an intermediate material (11).

Referring to FIG. 10, a thin layer of material (11) is bonded to the prepared end of a suitable fiber (7). In another method, a suitable mold is fabricated to the required geometry with the desired surface and mechanical properties. In the current embodiment, this is done on the end of an optical fiber. However, others skilled in the art could construct several other methods such as mechanical grinding, chemical etching, laser ablation or a multitude of different techniques either singly or in combination to achieve the same desired result.

Referring to FIG. 12, other techniques could utilize a precision ball (22) made from glass, ruby or other suitable material to achieve the desired profile. Indeed, someone skilled in the art would know that a multitude of materials could be used. A material (21), previously molded or bonded onto the end of the fiber (7) is then brought into contact with (22) in such a way as to provide an inverse replica of the profile of (22) on (21) before lens fabrication. However, not all embodiments would necessarily be confined to techniques that use additional materials. This leads to several other practical embodiments. Further, other means of obtaining the desired surface properties are also possible. For example, certain embodiments could have the surface of the fiber processed to provide a mirror of sufficient degree without the need for additional material. FIG. 13 shows one possible means of doing this. A fiber end (20) is impinged upon by an object (22) with its surface having the desired geometry and physical properties. The object (22) could be spinning about its axis but need not be. If necessary, a suitable material could be used between the fiber end (20) and the object (22) to promote formation of a suitable profile at the end of the fiber. The desired surface properties could be achieved at this time or further enhancement could be made by the addition of one or more layers of non-metallic or metallic coatings either singly or in combination. Further, other embodiments are possible that use a non-spherical surface. Specifically, elliptical surfaces would be useful for edge emitting laser diode tuning purposes. In addition a plethora of materials (21) could be deposited on the fiber end (20) and be subsequently processed by (22) to provide a suitable surface (10) which may or may not be subsequently re-processed by the addition of one or more layers of non-metallic or metallic coatings, either singly or in combination.

Selection of the material (FIG. 10, item 11) is critical. This material needs to have specific physical and optical properties. Not all materials possess these desirable properties. In the current embodiment, a specific plastic film was processed to achieve a desired radius of curvature. This film was then subjected to optical measurements and dimensional stability measurements after being exposed to elevated temperature. These measurements enabled the optimal material to be selected given the criteria employed. However, this does not mean inferior materials could be used and would be outside the current scope. Nor indeed that better materials could be found and used and be outside the current scope.

FIG. 14 shows the typical geometry of a concave lens. Upon achieving the desired radius of the curvature, it is possible to interferometrically measure the surface properties and characterize the surface. Referring again to FIG. 14, measurements of the surface show the surface roughness to be less than 6 Å, the radius of curvature to be ˜80 μm and the depth to be ˜1 μm. These are critical parameters and, as stated before, can be adjusted as desired to get the required properties. In addition to these measurements, other surfaces defects can be identified prior to depositing the mirrors and thus eliminate wasted effort on parts that will not yield.

FIG. 15 shows transmission characteristic of a concave and planar cavity as shown in FIG. 3, utilizing a concave lens similar to that shown in FIG. 14. In this case, the insertion loss is 2.5 dB, the Free Spectral Range (FSR) is 47 nm, the finesse is 610, the parasitic peak is −29 dB as scanned with tunable laser with a −35 dB noise floor. The parasitic peak is due to misalignment and an imperfect concave mirror and is thus a measure of how good these parameters are controlled. Thus, it can be shown that the current invention can achieve excellent, predictable performance from a very simple, controllable construction.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A fiber optic resonant cavity with mirrors on the fiber ends comprising;
a) The concave and planar mirrors which are optically aligned and fixed relative to each other such that the optical loss is minimized and desired optical characteristics are achieved;
b) Two concave mirrors which are optically aligned and fixed relative to each other such that the optical loss is minimized and desired optical characteristics are achieved;
c) The concave mirror and planar mirror on detector which are optically aligned and fixed relative to each other such that the optical loss is minimized and desired optical characteristics are achieved;
d) The concave mirror and VCSEL on planar mirror which are optically aligned and fixed relative to each other such that the optical loss is minimized and desired optical characteristics are achieved;
e) A cavity in which the length can be changed to select desired wavelength.

2. A method of fabricating a concave mirror according to claim (1) comprising;
a) A method of preparing a surface which is suitable for deposition of the smooth dielectric layers;
b) A method of selecting suitable multiple layer of dielectric materials for the mirror;
c) A method of selecting the thickness and material of layers to achieve the desired dielectric mirror optical properties;
d) A method of depositing low loss single or multiple dielectric layers on the surfaces;
e) A method of providing low stress dielectric layers on the surfaces;
f) A method for holding one or more parts during mirror deposition;
g) A method of measuring the optical properties of the dielectric mirrors;
h) A method of maintaining the shape of the indentation during the depositing of single or multiple dielectric layers on the concave lens;

3. A method of fabricating a concave lens according to claim (2) comprising;
a) A method of preparing a fiber end surface prior to attaching a plastic film;
b) A method of selecting a material which has a low optical loss;
c) A method of fabricating and attaching the plastic film (or layer of other suitable material) to the prepared fiber end;
d) A method of fabricating a smooth and stable indentation in the plastic film and surface;
e) A method of fabricating a smooth and stable indentation in a fiber surface;
f) A method of characterizing the geometry and location of an indentation;
g) A concave lens where the apex is precisely aligned to the core of the fiber;
h) A concave lens which has predetermined geometry and optical characteristics;
